(19) United States
(12) Patent Application Publication
(10) Pub. No.: US 2024/0286385 A1
(43) Pub. Date: Aug. 29, 2024

(54) MATERIALS COMPRISING A FUNCTIONAL COATING USED IN THE FORM OF LAMINATED AND MULTIPLE GLAZING

(71) Applicant: SAINT-GOBAIN GLASS FRANCE, COURBEVOIE (FR)

(72) Inventors: Yaël BRONSTEIN, ISSY-LES-MOULINEAUX (FR); Elsa PERRIN, PARIS (FR)

(21) Appl. No.: 18/576,692

(22) PCT Filed: Jun. 30, 2022
(86) PCT No.: PCT/FR2022/051314

§ 371 Date: Jan. 4, 2024

(30) Foreign Application Priority Data
Jul. 8, 2021 (FR) FR2107395

(51) Int. Cl. B32B 17/10

(52) U.S. Cl. CPC B32B 17/10229; B32B 17/10036; B32B 2255/205; B32B 2255/28; B32B 2307/412; B32B 2307/7376; B32B 2311/08; B32B 2315/08

(57) ABSTRACT

A material includes a transparent substrate coated with a functional coating, including, consecutively from the substrate, an alternation of three silver-based functional metal layers and four dielectric coatings (Di1, Di2, Di3 and Di4) which each have an optical thickness Eo1, Eo2, Eo3 and Eo4, each dielectric coating comprising at least one dielectric layer so that each functional metal layer is arranged between two dielectric coatings. The dielectric coating Di1 has an optical thickness Eo1 of less than 80 nm. The dielectric coating Di2 has an optical thickness Eo2 of less than 160 nm. The dielectric coating Di3 has an optical thickness Eo3 of less than 160 nm. The dielectric coating Di4 has an optical thickness Eo4 of less than 60 nm. Eo2/Eo1 is greater than 1.70 including this value. The thickness of the second functional metal layer is less than 12 nm. The thickness ratio Ag3/Ag1 is ≥1.20.

The invention relates to a material comprising a transparent substrate coated with a functional coating which can influence solar radiation and/or infrared radiation. The invention also relates to the glazed units comprising these materials and also to the use of such materials for manufacturing thermal insulation and/or solar protection glazed units.

In the following description, the term “functional” as used in “functional coating” means “capable of controlling solar radiation and/or infrared radiation”.

These glazed units are intended to equip either buildings or vehicles, especially in order to:
reduce climate control effort and/or prevent excessive heating, glazed units so-called “solar control,” and/or
reduce the amount of energy dissipated to the exterior, glazed units called “low emissive.”

The selectivity “S” enables the performance of these glazed units to be evaluated. It corresponds to the ratio of light transmission TLᵥᵢₛ in the visible range of the glazed unit to the solar factor SF of the glazed unit (S=TLᵥᵢₛ/SF). Solar factor “SF or g” is understood to mean the ratio in % of the total energy entering the premises through the glazed unit to the incident solar energy.

Selectivity is a key parameter of solar control glazed units.

Known selective glazed units comprise transparent substrates coated with a functional coating comprising a stack of one or more metallic functional layers, each arranged between two dielectric coatings. Such glazed units make it possible to improve solar protection while retaining a high light transmission. These functional coatings are generally obtained by a sequence of depositions carried out by cathode sputtering, optionally assisted by a magnetic field.

According to the intended applications and in particular according to the desired properties, these glazed units may be in the form of a monolithic glazed unit, a multiple glazed unit, a laminated glazed unit or a multiple and laminated glazed unit.

Conventionally, the faces of a glazed unit are designated starting from the exterior of the building and by numbering the faces of the substrates from the outside towards the inside of the passenger compartment or of the premises which it equips. This means that the incident sunlight passes through the faces in increasing numerical order.

The most effective known selective glazed units are generally double glazed units comprising the functional coating with at least three functional silver-based metallic layers located on face 2, that is to say on the outermost substrate of the building, on its face turned toward the interlayer gas gap.

There is currently an increasing demand for laminated solar control glazed units. These laminated glazed units in particular make it possible to improve the safety or to conform to the requirements of certain standards such as hurricane resistance standards.

Currently, the two most widely used configurations are double glazed units without lamination with a functional coating on face 2 and single laminated glazed units with a functional coating on face 2. In the “double-glazed unit without lamination” configuration, the functional coating is located facing the interlayer gas gap. In the “laminated glazed unit” configuration, the functional coating is located facing the lamination interlayer.

The functional coatings developed for double glazed unit applications cannot be used in laminate since their aesthetic qualities are generally not acceptable when the functional coating is in contact with the lamination interlayer. Very red or angled turquoise colors and a strong angular variation of the colors are often observed. Except in particular cases, these colors are not suitable because it is sought instead to obtain neutral or sometimes blue-green colors.

When it is desired to have a laminated glazed unit having defined colorimetric properties, it is therefore not possible to use the substrates coated with a functional coating developed for double glazed unit applications having these properties.

It is not possible in all cases to expect to have the same aesthetic appearance as for a double glazed unit if existing functional coatings are taken.

Indeed, the optical and colorimetric properties are different depending on whether the functional coating is in contact with the interlayer gas gap or the lamination interlayer. This is due to the differences in optical index existing between the gas gap (1.0) and the interlayer (1.5). The “functional coating/gas gap” and “functional/interlayer coating” interfaces behave differently optically.

For laminated applications, it is therefore necessary to modify the known functional coatings in order to obtain acceptable optics and the desired optical performances.

The processor or end user wishing to be able to provide multiple glazed units and laminated glazed units having equivalent optical properties must have two different ranges of materials in stock.

It would be particularly advantageous to have materials having equivalent optical properties, whether they are in the form of laminated glazed units or double glazed units. Indeed, arranging such materials greatly simplifies inventory management for the processor or end user.

The aim of the invention is therefore to overcome the disadvantages of the prior art by developing a glazed unit having equivalent optical properties, whether it is in the form of a multiple glazed unit when the functional coating is in contact with the interlayer gas gap or a laminated glazed unit when the functional coating is in contact with the lamination interlayer.

According to the invention, “optical properties” means the transmission and light reflection properties in the visible range and also the colorimetric properties.

Regarding the energy properties, it is impossible to obtain the same performance for laminated glazed units and non-laminated double glazed units. The solar factor will always be lower for non-laminated double glazed unit than for laminated glazed unit. Indeed, the laminated glazed units do not benefit from the thermal insulation of the gas gap present in multiple glazed units.

According to the invention, “material to be laminated” is understood to mean a material optimized to have the desired optical properties and the energy performance after the lamination step.

According to the invention, “laminable material” refers to an optimized material having the desired optical properties:
when it is in the form of a laminate, after the lamination step,
when it is in the form of a non-laminated double glazed unit.

The invention relates to a selective laminable material with high light transmission having a similar aesthetic effect that it is in the form of a non-laminated double glazed unit or a laminated glazed unit.

The applicant has surprisingly discovered a combination of features making it possible to obtain materials with high light transmission, which, mounted in the form of double glazed units or in the form of laminated glazed units, have similar optical properties. The materials comprise functional coatings with three silver layers. The combination of features relates to the thicknesses of the silver layers and of the dielectric coatings.

The invention relates in particular to a material comprising a transparent substrate coated with a functional coating successively including, starting from the substrate, an alternation of three silver-based functional metal layers referred to, starting from the substrate, as first, second and third functional layers and of four dielectric coatings, referred to, starting from the substrate Di1, Di2, Di3 and Di4 which each have an optical thickness, as Eo1, Eo2, Eo3 and Eo4, each dielectric coating including at least one dielectric layer, so that each functional metal layer is positioned between two dielectric coatings, characterized in that:
the dielectric coating Di1 has an optical thickness Eo1 of less than 80 nm,
the dielectric coating Di2 has an optical thickness Eo2 of less than 160 nm,
the dielectric coating Di3 has an optical thickness Eo3 of less than 160 nm,
the dielectric coating Di4 has an optical thickness Eo4 of less than 60 nm,
the ratio of the optical thicknesses Eo2/Eo1 is greater than 1.70 including this value,
the thickness of the second functional metal layer is less than 12 nm,
the ratio of the thickness of the third functional metal layer to the thickness of the first functional metal layer Ag3/Ag1 is greater than or equal to 1.20.

The invention also relates:
to a glazed unit comprising a material according to the invention,
to a glazed unit comprising a material according to the invention mounted on a vehicle or on a building,
to the process for preparing a material or a glazed unit according to the invention,
to the use of a glazed unit according to the invention as solar-control and/or low-emissivity glazed unit for buildings or vehicles,
to a building, vehicle or device comprising a glazed unit according to the invention.

The invention therefore relates to a glazed unit comprising at least one material according to the invention in the form of a monolithic, laminated or multiple glazed unit, in particular double glazed unit or triple glazed unit.

The coating is advantageously positioned in the glazed unit so that the incident light originating from the outside passes through the first dielectric coating before passing through the first functional metal layer.

The invention relates to a multiple glazed unit comprising a material and at least one additional substrate, the material and the additional substrate are separated by at least one interlayer gas gap.

The invention relates to a laminated glazed unit comprising a material and at least one additional substrate, the material and the additional substrate are separated by at least one lamination gas gap.

The preferred features which appear in the remainder of the description are applicable as well to the material according to the invention as, where appropriate, to the glazed unit, the method, the use, the building or the vehicle according to the invention.

All the light characteristics presented in the description are obtained according to the principles and methods described in the European standard EN 410 relating to the determination of the light and solar characteristics of the glazed units used in glass for the construction industry.

Conventionally, the refractive indices are measured at a wavelength of 550 nm.

Unless otherwise mentioned, the thicknesses mentioned in the present document, without other information, are real or geometrical physical thicknesses denoted Ep and are expressed in nanometers (and not optical thicknesses). The optical thickness Eo is defined as the physical thickness of the layer under consideration multiplied by its refractive index at the wavelength of 550 nm: Eo=n*Ep. As the refractive index is a dimensionless value, it may be considered that the unit of the optical thickness is that chosen for the physical thickness.

According to the invention, a dielectric coating corresponds to a sequence of layers comprising at least one dielectric layer, located between the substrate and the first functional layer (Di1), between two functional layers (Di2 or Di3) or above the final functional layer (Di4).

If a dielectric coating is composed of several dielectric layers, the optical thickness of the dielectric coating corresponds to the sum of the optical thicknesses of the different dielectric layers constituting the dielectric coating.

If a dielectric coating comprises an absorbing layer, for which the refractive index at 550 nm comprises an imaginary part of the non-zero (or non-negligible) dielectric function, for example a metal layer, the thickness of this layer is not taken into account in calculating the optical thickness of the dielectric coating.

The thicknesses of the blocking layers are not taken into account in calculating the optical thickness of the dielectric coating.

Within the meaning of the present invention, the labels “first”, “second”, “third” and “fourth” for the functional layers or the dielectric coatings are defined starting from the substrate carrying the stack and with reference to the layers or coatings having the same function. For example, the closest functional layer to the substrate is the first functional layer, the following moving away from the substrate is the second functional layer, and so on.

The light characteristics are measured using the illuminant D65 at 2° perpendicularly to the material mounted in a double glazed unit (unless otherwise indicated):
TL corresponds to light transmission in the visible range in %,
Rext corresponds to the exterior light reflection in the visible range in %, observer on the exterior space side,
Rint corresponds to the interior light reflection in the visible range in %, observer on the interior space side,
a*T and b*T correspond to the colors in transmission a* and b* in the L*a*b* system,
a*Rext and b*Rext correspond to the colors in reflection a* and b* in the L*a*b* system, observer on the exterior space side,
a*Rint and b*Rint correspond to the colors in reflection a* and b* in the L*a*b* system, observer on the interior space side,
a*Rext 60° and b*Rext 60° corresponding to the colors in reflection a* and b* in the L*a*b* system at an angle of 60° relative to the normal to the plane of the glazed unit, observer on the exterior space side.

In the configurations in the form of double glazed units (hereinafter DGUs for “double glazed units”), colorimetric properties such as L*, a* and b* values and all the values and ranges of values of the optical and thermal characteristics such as selectivity, exterior or interior light reflection, the light transmission is calculated with:
materials comprising a substrate coated with a functional coating mounted in a double glazed unit,
the double glazed unit has a configuration: 4-16(Ar-90%)-4, that is to say a configuration made up of a material comprising a substrate of ordinary soda-lime glass type of 4 mm and another glass substrate of soda-lime glass type of 4 mm, the two substrates are separated by an interlayer gas gap formed of 90% argon and 10% air with a thickness of 16 mm,
the functional coating is preferably positioned on face 2, that is to say on the outermost substrate of the building, on its face turned toward the interlayer gas gap.

In the configurations in the form of laminated glazed units (hereinafter Lam.), colorimetric properties such as L*, a* and b* values and all the values and ranges of values of the optical and thermal characteristics such as selectivity, exterior or interior light reflection, the light transmission is calculated with:
materials comprising a substrate coated with a functional coating mounted in a laminated glazed unit,
the laminated glazed unit comprises a material comprising a substrate comprising 4 mm ordinary soda-lime glass and another 4 mm glass substrate of soda-lime glass, the two substrates are separated by a 0.76 mm PVB lamination interlayer,
the functional coating is preferably positioned on face 2 on its face turned toward the lamination interlayer.

According to the invention, a material is said to be “laminable” when it has similar colors in the non-laminated double glazed unit configuration and in the laminated glazed unit configuration.

This may result in maximum gaps permitted between the following configurations:
in light transmission

$$- Δ TL ( \% ) = \vert {T}_{DGU} - {TL}_{L a m} \vert < 4$$

$$- Δ a * T ( \% ) = \vert a * {T}_{DGU} - a * {T}_{L a m} \vert < 3$$

$$- Δ b * T ( \% ) = \vert b * {T}_{DGU} - b * {T}_{L a m} \vert < 3$$

in exterior light reflection:

$$- Δ RLext ( \% ) = \vert {RLext}_{DGU} - {RLext}_{Lam} \vert < 4$$

$$- Δ a * Rext ( \% ) = \vert a * {Rext}_{DGU} - a * {Rext}_{L a m} \vert < 3$$

$$- Δ b * Rext ( \% ) = \vert b * {Rext}_{DGU} - b * {Rext}_{L a m} \vert < 3$$

in exterior light reflection at angle)(60°:

$$- Δ a * Rext 60 ° ( \% ) = \vert a * Rext 60 {°}_{DGU} - a * Rext 60 {°}_{L a m} \vert < 3$$

$$- Δ b * Rext 60 ° ( \% ) = \vert b * Rext 60 {°}_{DGU} - b * Rext 60 {°}_{L a m} \vert < 3.$$

These deviations ensure that two glazed units distant from these maximum deviations are visually similar.

The Delta C* representing the variation between the colors obtained in double glazed unit and in laminated glazed unit defined by (a*_{DGU}, b*_{DGU}) and (a*_{Lam}, b*_{Lam}) in transmission or in reflection is calculated by the following formula:

$$Delta C *= √ ( {( a {*}_{DGU} - a {*}_{L a m} )}^{2} + {( b {*}_{DGU} - b {*}_{L a m} )}^{2} )$$

The laminable nature may also be reflected by values of Delta C* (color deviation) below:
in transmission: Delta C*max=4.2,
in exterior reflection: Delta C*max=4.2,
in interior reflection: Delta C*max=8.5,
in exterior reflection at 60°: Delta C*max=4.2.

The difference allowed between the double glazed unit and the laminate is more restricted in transmission and in exterior reflection than in interior reflection, the latter being less visible.

The invention therefore also relates to a glazed unit in the form of a double glazed unit or of a laminated glazed unit, the variations in color between a material mounted in the form of double glazed unit with the functional coating positioned on face 2 and a material mounted in the form of laminated glazed unit with the functional coating positioned on face 2 defined by Delta C*, where Delta C*=√(a*_{DGU}−a*_{Lam})²−(b*_{DGU}−b*_{Lam})²) satisfy:
in transmission: Delta C*<4.2,
in exterior reflection: Delta C*<4.2,
in interior reflection: Delta C*<8.5,
in exterior reflection at 60°: Delta C*<4.2,
   where a*_{DGU} and b*_{DGU} are the colorimetric coordinates of the material mounted in the form of a double glazed unit and a*_{Lam} and b*_{Lam} are the colorimetric coordinates of the material mounted in the form of laminated glazed unit in transmission, in exterior reflection, in interior reflection.

The material according to the invention has the following characteristics:
an interior and exterior light reflection less than 20%, and/or
a light transmission greater than 50%, greater than 55%, greater than 60%, between 50% and 70%, between 60% and 70% or between 65% and 69%.

These values are obtained for the material alone. A material alone corresponds to a monolithic glazed unit.

The material according to the invention, in the form of multiple and/or laminated glazed unit, also makes it possible to obtain the following advantageous properties:
a light transmission greater than 50%, greater than 55%, greater than 60%, between 50% and 70%, between 55% and 65% or between 58% and 62% and/or
an exterior reflection of less than 20%.

Preferably, the material confers on the glazed units the incorporating of neutral colors. According to the invention, neutral transmission and exterior reflection colors or in interior reflection are defined by:
values of a* comprised, by increasing order of preference, between −10 and 0, between −4 and 0, between −3 and 0, between −2 and 0, between −1 and 0 and/or
values of b* comprised, by increasing order of preference, between −10 and +5, between −5 and 0, between −3 and 0, between −2 and 0, between −1 and 0.

According to advantageous embodiments, the glazed unit of the invention in the form of a double glazed unit comprising the functional coating positioned on face 2, in particular:
a high selectivity, in order of increasing preference, of at least 1.7, greater than 1.8, of at least 1.9, of at least 2.0, of at least 2.1 and/or
a solar factor g of less than or equal to 40%, of less than or equal to 35%, of less than or equal to 30%, of between 25 and 35% and/or
a solar factor g greater than or equal to 26% and/or
an interior and exterior light reflection less than 20%, and/or
a light transmission of greater than 50%, of greater than 55%, of greater than 60%, of between 40% and 70%, of between 50% and 70%, of between 50% and 65%, of between 55% and 65%, or between 58% and 62% and/or
exterior reflection values of a* at 0 and 60° and transmission values comprised, by increasing order of preference, between −10 and +0, between −5 and +0, and/or
exterior reflection values of b* at 0 and 60° and transmission values comprised, by increasing order of preference, between −10 and +5, between −5 and +0.

According to advantageous embodiments, the glazed unit of the invention, in the form of a laminated glazed unit comprising the functional coating positioned on face 2, makes it possible in particular to achieve the following performance:
a light transmission greater than 50%, greater than 55%, greater than 60%, between 50% and 70%, between 55% and 65% or between 58% and 62% and/or
an exterior side reflection of less than 25%, less than 22%, less than 20% and/or
neutral colors in transmission and in exterior reflection at 0° and 60°:
a* between −10 and 0;
b* between −10 and 5, and/or
an aesthetic appearance in transmission and in exterior reflection (at 0° and at an angle) close to that of a double glazed unit.

These glazed units may be assembled on a building or a vehicle.

The invention thus also relates:
to a glazed unit mounted on a vehicle or on a building, and
to a vehicle or building comprising a glazed unit according to the invention.

A glazed unit for the building generally delimits two spaces, an “exterior” space and an “interior” space. It is considered that the sunlight entering a building goes from the outside to the inside.

According to the invention, the glazed units used as a constituent element of balustrades, balconies and/or railings are also included in “building” applications.

The invention also relates:
to the process for preparing a material or a glazed unit according to the invention,
to the use of a glazed unit according to the invention as solar-control and/or low-emissivity glazed unit for buildings or vehicles.

The functional coating is deposited by magnetic-field-assisted cathode sputtering (magnetron method). According to this advantageous embodiment, all the layers of coatings are deposited by magnetic-field-assisted cathode sputtering.

The invention also relates to the method for obtaining a material and a glazed unit according to the invention, wherein the layers of coatings are deposited by magnetron cathode sputtering.

Unless specifically stipulated, the expressions “above” and “below” do not necessarily mean that two layers and/or coatings are positioned in contact with one another. When it is specified that a layer is deposited “in contact” with another layer or with a coating, this means that there cannot be one (or several) layer(s) inserted between these two layers (or layer and coating).

In the present description, unless otherwise indicated, the expression “based on”, used to characterize a material or a layer with respect to what it contains, means that the mass fraction of the constituent that it comprises is at least 50%, in particular at least 70%, preferably at least 90%.

According to the invention:
light reflection corresponds to the reflection of solar radiation in the visible part of the spectrum,
light transmission corresponds to the transmission of solar radiation in the visible part of the spectrum,
light absorption corresponds to the absorption of solar radiation in the visible part of the spectrum.

Ordinary clear glass from 4 to 6 mm thick has the following light characteristics:
light transmission between 87.5 and 91.5%,
light reflection between 7 and 9.5%,
light absorption between 0.3 and 5%.

The functional coating comprises at least three silver-based functional metal layers (F1, F2 and F3), each arranged between two dielectric coatings (Di1, Di2, Di3, Di4).

The silver-based functional metal layers comprise at least 95.0%, preferably at least 96.5% and better still at least 98.0% by weight of silver, relative to the weight of the functional layer. Preferably, a silver-based functional metal layer comprises less than 1.0% by weight of metals other than silver, relative to the weight of the silver-based functional metal layer.

The three functional metal layers can satisfy the following characteristics:
the first silver-based functional metal layer has a thickness between 7 and 11 nm, preferably between 7 and 10 nm, and/or
the second silver-based functional metal layer has a thickness between 9 and 12 nm exclusive, preferably between 9 and 10 nm, and/or
the third silver-based functional metal layer has a thickness between 12 and 18 nm, preferably between 13 and 17 nm, and/or
the ratio of the thickness of the second functional metal layer to the thickness of the first functional metal layer Ag2/Ag1 is comprised between 1.05 and 2.00, between 1.10 and 1.80, or between 1.10 and 1.50 inclusive, and/or
the ratio of the thickness of the third functional metal layer to the thickness of the second functional metal layer Ag3/Ag2 is comprised between 1.05 and 2.00, between 1.10 and 1.80, or between 1.20 and 1.7 inclusive, and/or
the ratio of the thickness of the third functional metal layer to the thickness of the first functional metal layer Ag3/Ag1 is comprised between 1.20 and 3.00 or between 1.50 and 2.50 inclusive.

The thicknesses of the functional metal layers starting from the substrate can increase. In such a case, the increase in thickness between two successive functional layers is greater than 0.8 nm, greater than 1 nm, greater than 1.5 nm.

The ratio of the thickness between two successive functional layers is between 1.05 and 2.30 or between 1.1 and 2.30 inclusive.

The stack may further comprise at least one blocking layer located in contact with a functional metal layer.

The blocking layers conventionally have the role of protecting the functional layers from possible damage during the deposition of the upper antireflective coating and during a possible high-temperature heat treatment of the annealing, bending and/or tempering type.

The blocking layers are chosen from:
metal layers based on a metal or a metal alloy, metal nitride layers, and metal oxynitride layers of one or more elements chosen from titanium, zinc, tin, nickel, chromium and niobium,
metal oxide layers of one or more elements chosen from titanium, nickel, chromium and niobium.

The blocking layers may in particular be Ti, TiN, TiOx, Nb, NbN, Ni, NiN, Cr, CrN, NiCr, NiCrN, SnZnN layers. When these blocking layers are deposited in the metal, nitride or oxynitride form, these layers can undergo a partial or complete oxidation according to their thickness and the nature of the layers which surround them, for example, during the deposition of the following layer or by oxidation in contact with the underlying layer.

According to advantageous embodiments of the invention, the blocking layer or layers satisfy one or several of the following conditions:
each silver-based functional metal layer can be located below and/or above, and optionally in contact with, a blocking layer in contact chosen from a blocking underlayer and a blocking overlayer, and/or
the blocking layer can be based on at least one element chosen from nickel, chromium, niobium, tantalum and titanium, and/or
each functional metal layer is in contact with a blocking overlayer, and/or
the thickness of each blocking layer is at least 0.1 nm, preferably comprised between 0.2 and 2.0 nm.

According to the invention, the blocking layers are considered as not forming part of a dielectric coating. This means that their thickness is not taken into account in calculating the optical or geometric thickness of the dielectric coating located in contact therewith.

“Dielectric layer” within the meaning of the present invention should be understood as meaning that, from the perspective of its nature, the material is “nonmetallic”, that is, is not a metal. In the context of the invention, this term denotes a material exhibiting an n/k ratio over the entire wavelength range of the visible region (from 380 nm to 780 nm) which is equal to or greater than 5.

The dielectric layers of the coatings exhibit the following characteristics, alone or in combination:
they are deposited by magnetic-field-assisted cathode sputtering, and/or
they are chosen from oxides or nitrides of one or several elements chosen from titanium, silicon, aluminum, zirconium, tin and zinc, and/or
they are selected from
the oxide layers of one or more elements selected from titanium, silicon, aluminum, zirconium, iron, chromium, cobalt, manganese, tungsten, niobium, bismuth, tantalum, zinc and/or tin,
the nitride layers of one or more elements chosen from silicon, zirconium and aluminum,
the oxynitride layers of one or more elements chosen from silicon, zirconium and aluminum,
the metal sulfide layers such as zinc sulfide, and/or
they have a thickness of greater than 2 nm, preferably between 4 and 100 nm.

According to advantageous embodiments of the invention, the dielectric coatings of the functional coatings satisfy one or several of the following conditions:
the dielectric layers may be based on an oxide or on a nitride of one or several elements chosen from silicon, zirconium, titanium, aluminum, tin, zinc, and/or
at least one dielectric coating includes at least one dielectric layer having a barrier function, and/or
each dielectric coating includes at least one dielectric layer having a barrier function, and/or
the dielectric layers having a barrier function are based on compounds of silicon and/or aluminum chosen from oxides, such as SiO₂ and Al₂O₃, nitrides Si₃N₄ and AlN, and oxynitrides SiOₓN_{y} and AlOₓN_{y}, based on zinc and tin oxide, or based on titanium oxide,
the dielectric layers having a barrier function are based on compounds of silicon and/or aluminum optionally comprise at least one other element, such as aluminum, hafnium and zirconium, and/or
at least one dielectric coating comprises at least one dielectric layer having a stabilizing function, and/or
each dielectric coating comprises at least one dielectric layer having a stabilizing function, and/or
the dielectric layers having a stabilizing function are preferably based on an oxide chosen from zinc oxide, tin oxide, zirconium oxide or a mixture of at least two of them, and/or
the dielectric layers having a stabilizing function are preferably based on crystalline oxide, in particular based on zinc oxide, optionally doped using at least one other element, such as aluminum, and/or
each functional layer is above a dielectric coating, the upper layer of which is a dielectric layer having a stabilizing function, preferably based on zinc oxide, and/or below a dielectric coating, the lower layer of which is a dielectric layer having a stabilizing function, preferably based on zinc oxide.

Preferably, each dielectric coating consists solely of one or more dielectric layers. Preferably, there is thus no absorbing layer in the dielectric coatings, in order not to reduce the light transmission.

The dielectric layers may have a barrier function. Dielectric layers having a barrier function (hereinafter barrier layer) is understood to mean a layer made of a material capable of forming a barrier to the diffusion of oxygen and water at high temperatures, originating from the ambient atmosphere or from the transparent substrate, toward the functional layer. Such dielectric layers are selected from layers:
based on silicon and/or aluminum compounds chosen from oxides such as SiO₂ and Al₂O₃, nitrides, such as nitrides Si₃N₄ and AlN, and oxynitrides such as SiOₓN_{y}, AlOₓN_{y} optionally doped using at least one other element,
based on zinc tin oxide,
based on titanium oxide.

Preferably, each coating includes at least one dielectric layer consisting of:
an aluminum and/or silicon nitride or oxynitride, or
a mixed zinc and tin oxide, or
a titanium oxide.

These dielectric layers have a thickness:
of less than or equal to 80 nm, of less than or equal to 60 nm or of less than or equal to 25 nm, and/or
of greater than or equal to 5 nm, of greater than or equal to 10 nm or of greater than or equal to 15 nm.

The functional coatings of the invention may comprise dielectric layers having a stabilizing function. Within the meaning of the invention, “stabilizing” means that the nature of the layer is selected so as to stabilize the interface between the functional layer and this layer. This stabilization results in the strengthening of the adhesion of the functional layer to the layers that surround it, and in fact will oppose the migration of its constituent material.

The dielectric layer or layers having a stabilizing function can be directly in contact with a functional layer or separated by a blocking layer.

Preferably, the final dielectric layer of each dielectric coating located below a functional layer is a dielectric layer having a stabilizing function. This is because it is advantageous to have a layer having a stabilizing function, for example based on zinc oxide, below a functional layer as it facilitates the adhesion and the crystallization of the silver-based functional layer and increases its quality and its stability at high temperature.

It is also advantageous to have a layer having a stabilizing function, for example based on zinc oxide, above a functional layer in order to increase the adhesion thereof and to optimally oppose the diffusion on the side of the stack opposite the substrate.

The dielectric layer or layers having a stabilizing function can thus be above and/or below at least one functional layer or each functional layer, either directly in contact therewith or separated by a blocking layer.

Advantageously, each dielectric layer having a barrier function is separated from a functional layer by at least one dielectric layer having a stabilizing function.

The zinc oxide layer may optionally be doped by means of at least one other element, such as aluminum. The zinc oxide is crystallized. The layer based on zinc oxide comprises, in increasing order of preference, at least 90.0%, at least 92%, at least 95%, at least 98.0% by mass of zinc relative to the mass of elements other than oxygen in the zinc oxide-based layer.

Preferably, the dielectric coatings of the functional coatings comprise a dielectric layer based on zinc oxide located beneath the silver-based metal layer.

The zinc oxide layers have, in increasing order preferably, a thickness of:
at least 3.0 nm, at least 4.0 nm, at least 5.0 nm, and/or
at most 25 nm, at most 10 nm, at most 8.0 nm.

According to advantageous embodiments of the invention, the dielectric coatings satisfy one or more of the following conditions in terms of thicknesses:
the dielectric coatings Di1, Di2, Di3 and Di4 each have an optical thickness Eo1, Eo2, Eo3 and Eo4 satisfying one or more of the following relationships: Eo4<Eo1, Eo4<Eo2, Eo1<Eo3, and/or
the dielectric coating Di1 has an optical thickness of between 20 to 80 nm, between 30 to 80 nm, between 57 to 80 nm, and/or
the dielectric coating Di2 has an optical thickness of between 80 to 160 nm, between 90 to 150 nm, between 100 to 150 nm, between 110 and 145 nm, between 124 and 144 nm, and/or
the dielectric coating Di4 has an optical thickness of between 80 to 160 nm, between 90 to 150 nm, between 100 to 150 nm, between 124 and 160 nm, between 144 and 160 nm, and/or
the dielectric coating Di4 has an optical thickness between 30 and 60 nm, between 30 and 55 nm.

The functional coating may optionally comprise an upper protective layer. The upper protective layer is preferably the last layer of the stack, that is, the layer furthest from the substrate coated with the stack. These upper protective layers are regarded as included in the last dielectric coating. These layers generally have a thickness comprised between 2 and 10 nm, preferably 2 and 5 nm.

The protective layer may be selected from a layer of titanium, zirconium, hafnium, zinc and/or tin, this or these metals being in the metal, oxide or nitride form. Advantageously, the protective layer is a layer of titanium oxide, a layer of tin zinc oxide or a layer based on titanium zirconium oxide.

Another particularly advantageous embodiment relates to a substrate coated with a stack, defined starting from the transparent substrate, comprising:
a first dielectric coating comprising at least one layer having a barrier function and one dielectric layer having a stabilizing function,
optionally a blocking layer,
a first functional layer,
optionally a blocking layer,
a second dielectric coating comprising at least one lower dielectric layer having a stabilizing function, one layer having a barrier function and one upper dielectric layer having a stabilizing function,
optionally a blocking layer,
a second functional layer,
optionally a blocking layer,
a third dielectric coating comprising at least one lower dielectric layer having a stabilizing function, one layer having a barrier function, one upper dielectric layer having a stabilizing function,
optionally a blocking layer,
a third functional layer,
optionally a blocking layer,
a fourth dielectric coating comprising at least one dielectric layer having a stabilizing function, a layer having a barrier function,
optionally a protective layer.

Another particularly advantageous embodiment comprises a stack which comprises, starting from the substrate:
a first dielectric coating comprising at least one layer based on sodium nitride and a layer based on zinc oxide,
optionally a blocking layer,
a first functional layer,
optionally a blocking layer,
a second dielectric coating comprising at least three successive layers, a layer based on zinc oxide, a layer based on silicon nitride, and a layer based on zinc oxide,
optionally a blocking layer,
a second functional layer,
optionally a blocking layer,
a third dielectric coating comprising at least three successive layers, a layer based on zinc oxide, a layer based on silicon nitride, and a layer based on zinc oxide,
optionally a blocking layer,
a third functional layer,
a blocking layer,
a fourth dielectric coating comprising at least one layer based on zinc oxide, a layer based on silicon nitride and
optionally a protective layer.

The transparent substrates according to the invention are preferably made of a rigid inorganic material, such as made of glass, or are organic, based on polymers (or made of polymer).

The organic transparent substrates according to the invention can also be made of polymer, and are rigid or flexible. Examples of polymers which are suitable according to the invention comprise, especially:
polyethylene,
polyesters, such as polyethylene terephthalate (PET), polybutylene terephthalate (PBT) or polyethylene naphthalate (PEN);
polyacrylates, such as polymethyl methacrylate (PMMA);
polycarbonates;
polyurethanes;
polyamides;
polyimides;
fluorinated polymers, such as fluoroesters, such as ethylene-tetrafluoroethylene (ETFE), polyvinylidene fluoride (PVDF), polychlorotrifluoroethylene (PCTFE), ethylene-chlorotrifluoroethylene (ECTFE), fluorinated ethylene-propylene copolymers (FEP);
photocrosslinkable and/or photopolymerizable resins, such as thiolene, polyurethane, urethane-acrylate, polyester-acrylate resins, and
polythiourethanes.

The substrate is preferably a sheet of glass or of glass-ceramic.

The substrate is preferably transparent, colorless (it is then a clear or extra-clear glass) or colored, for example blue, gray or bronze. The glass is preferably soda-lime-silica type but it can also be a glass of borosilicate or alumino-borosilicate type.

According to a preferred embodiment, the substrate is made of glass, especially soda-lime-silica glass, or of polymer organic material.

The substrate advantageously has at least one dimension greater than or equal to 1 m, even 2 m and even 3 m. The thickness of the substrate generally varies between 0.5 mm and 19 mm, preferably between 0.7 and 9 mm, especially between 2 and 8 mm, even between 4 and 6 mm. The substrate may be flat or curved, indeed even flexible.

The material according to the invention can be in the form of a monolithic, laminated and/or multiple glazed unit, in particular double glazed unit or triple glazed unit.

A monolithic glazed unit comprises a material according to the invention. The surface 1 is outside the building and thus constitutes the exterior wall of the glazed unit and surface 2 is inside the building and thus constitutes the interior wall of the glazed unit.

A multiple glazed unit comprises a material and at least one additional substrate, the material and the additional substrate are separated by at least one interlayer gas gap. The glazed unit provides a separation between an exterior space and an interior space.

A double glazed unit, for instance, includes 4 surfaces; surface 1 is outside the building and thus constitutes the exterior wall of the glazed unit, surface 4 is inside the building and thus constitutes the interior wall of the glazed unit, surfaces 2 and 3 being inside the double glazed unit.

A laminated glazed unit comprises a material and at least one additional substrate; the material and the additional substrate are separated by at least one lamination interlayer. A laminated glazed unit therefore includes at least one structure of the material/lamination interlayer/additional substrate type. In the case of a laminated glazed unit, all the surfaces of the additional materials and substrates are numbered but the surfaces of the laminating interlayers are not numbered. The surface 1 is outside the building and thus constitutes the exterior wall of the glazed unit, surface 4 is inside the building and thus constitutes the interior wall of the glazed unit, surfaces 2 and 3 being in contact with the lamination interlayer.

A multiple laminated glazed unit comprises a material and at least two additional substrates corresponding to a second substrate and a third substrate, the material and the third substrate are separated by at least one interlayer gas gap, and
the material and the second substrate or
the second substrate and the third substrate, are separated by at least one lamination interlayer.

The lamination interlayers can be chosen from among sheets of thermoplastic material, for example made of polyurethane (PU), of polyvinyl butyral (PVB), of ethylene-vinyl acetate (EVA), of ethylene (ionomer) copolymer or of a multi-component or mono-component resin that can be crosslinked thermally (epoxy, PU) or ultraviolet (epoxy, acrylic resin).

Conventionally, the interlayers have a thickness of between 0.20 and 3.00 mm.

An interlayer may be composed of one or more polymer sheets. The thickness ranges given are the total thicknesses of the interlayer.

The material, that is to say the substrate coated with the functional coating, can undergo a high-temperature heat treatment, such as an annealing, for example by a flash annealing, such as a laser or flame annealing, a tempering and/or a bending. The temperature of the heat treatment is greater than 400° C., preferably greater than 450° C. and better still greater than 500° C. The coated substrate of the functional coating can thus be bent and/or tempered.

The details and advantageous characteristics of the invention emerge from the following nonlimiting examples.

### EXAMPLES

### I. Nature of the Layers and Coatings

Functional coatings defined below are deposited on substrates made of clear soda-lime glass with a thickness of 4 mm.

The functional metal layers (FL) are silver (Ag) layers. The blocking layers are metallic layers made of nickel-chromium alloy (NiCr). The dielectric coatings of the functional coatings comprise barrier layers and stabilizing layers. The barrier layers are based on silicon nitride, doped with aluminum (Si₃N₄: Al) or based on a mixed oxide of zinc and tin (SnZnOx). The stabilizing layers are made of zinc oxide (ZnO).

The conditions for deposition of the layers, which were deposited by sputtering (“magnetron cathode” sputtering), are summarized in table 1.

TABLE 1

| | | Deposition | |
|---|---|---|---|
| | Target used | pressure | Gas |
| Si₃N_{₄} | Si:Al at 92:8% by weight | 3.2 · 10 − 3 mbar | Ar/(Ar + N2) |
| | | | at 55% |
| ZnO | Zn:Al at 98:2% by weight | 1.8 · 10 − 3 mbar | Ar/(Ar + O2) |
| | | | at 63% |
| SnZnOx | Sn:Zn (60:40% by wt) | 1.5*10⁻³ mbar | Ar/(Ar + O2) |
| | | | at 39% |
| NiCr | Ni (80 at. %):Cr (20 at. %) | 2 − 3 · 10⁻³ mbar | Ar at 100% |
| Ag | Ag | 3 · 10 − 3 mbar | Ar at 100% |

At. = atomic.

### III. Functional Coatings

Table 2 lists the materials and the physical thicknesses in nanometers (unless otherwise indicated) for each layer or coating that forms the coatings as a function of their position with respect to the substrate bearing the stack (final line at the bottom of the table).

TABLE 2

| | M1 | M2 | CM1 | CM2 | CM3 |
|---|---|---|---|---|---|
| DC: M4 | | | | | |
| Si₃N₄ | 17 | 17 | 31 | | 23 |
| ZnO | 8 | 8 | 8 | | 8 |
| BL: NiCr | 0.1 | 0.3 | 0.1 | | 0.1 |
| FL: Ag3 | 16 | 14 | 20 | | 19 |
| DC: M3 | | | | | |
| ZnO | 8 | 8 | 8 | | 8 |
| SnZnO | 8 | 8 | 8 | | 8 |
| Si₃N₄ | 50 | 50 | 57 | 15 | 54 |
| ZnO | 10 | 10 | 10 | 10 | 10 |
| BL: NiCr | 0.3 | 0.1 | 0.3 | 2 | 0.3 |
| FL: Ag2 | 10 | 11 | 12 | 9 | 12 |
| BL: NiCr | 0.1 | 0.3 | 0.1 | 0.1 | 0.1 |
| DC: M2 | | | | | |
| ZnO | 8 | 8 | 8 | 8 | 8 |
| Si₃N₄ | 48 | 53 | 57 | 55 | 53 |
| ZnO | 8 | 8 | 8 | 8 | 8 |
| BL: NiCr | 0.4 | 0.3 | 0.4 | 0.1 | 0.1 |
| FL: Ag1 | 8 | 9 | 9 | 7 | 7 |
| BL: NiCr | 0.1 | 0.1 | 0.1 | 0.5 | 0.1 |
| DC: M1 | | | | | |
| ZnO | 4 | 4 | 4 | 4 | 4 |
| Si₃N₄ | 26 | 28 | 42 | 27 | 31 |
| Substrate (mm) | 4 | 4 | 4 | 4 | 4 |

DC: Dielectric coating; BL: Blocking layer; FL: Functional layer.

TABLE 3

| | Targets | M1 | M2 | CM1 | CM2 | CM3 |
|---|---|---|---|---|---|---|
| Eo4 | <60 | 50 | 50 | 79 | — | 62 |
| Eo3 | <160 | 152 | 152 | 166 | 50 | 160 |
| Eo2 | <160 | 128 | 138 | 146 | 142 | 138 |
| Eo1 | <80 | 61 | 65 | 94 | 63 | 71 |
| Eo2/Eo1 | >1.7 | 2.1 | 2.1 | 1.5 | 2.2 | 1.94 |
| Ag2 | <12 | 10 | 11 | 12 | 9 | 12 |
| Ag3/Ag1 | >1.2 | 2 | 1.5 | 2.2 | — | 2.7 |

### IV. Configurations of the Double Glazed Units and Laminated Glazed Units

The materials comprising a transparent substrate, one of the faces of the substrate of which is coated with a functional coating, have been assembled in the form of a double glazed unit or in the form of a laminated glazed unit.

The double glazed units, hereinafter “DGU” configuration, have a 4/16/4 structure: 4 mm glass/16 mm interlayer space filled with 90% argon and 10% air/4 mm glass, the functional coating being positioned on face 2.

Laminated glazed units, hereinafter “Lam.”, have a structure of the first substrate 4 mm/sheet(s)/second substrate 4 mm. The functional coating is positioned on face 2.

### V. “Solar Control” and Colorimetry Performance

TABLE 4

| | | M1 | M1 | M2 | M2 | CM1 | CM1 | CM2 | CM2 | CM3 | CM3 |
|---|---|---|---|---|---|---|---|---|---|---|---|
| Property | Targets | DGU | Lam | DGU | Lam | DGU | Lam | DGU | Lam | DGU | Lam |
| TL (%) | 55-65% | 58.9 | 60.7 | 58.5 | 61.0 | 60.2 | 55.8 | 57.9 | 60.9 | 60 | 57 |
| a*T | [−10; 0] | −3.6 | −5.9 | −4.0 | −5.7 | −4.2 | −3.7 | −4.2 | −5.5 | −5.5 | −4 |
| b*T | [−10; 5] | −1.1 | 1.1 | −1.1 | 0.0 | −0.3 | 1.4 | −2.9 | −2.4 | 3 | 6.5 |
| RLext (%) | <20% | 12.8 | 11.8 | 11.8 | 10.6 | 12 | 15.7 | 9 | 8.5 | 14.5 | 16.7 |
| a*Rext | [−10; 0] | −4.1 | −4.6 | −1.1 | −3.1 | −2.3 | −5.3 | −5.1 | 1.5 | −3.5 | −11 |
| b*Rext | [−10; 5] | 0.7 | −2.0 | −1.9 | −1.3 | −7 | −8.2 | −0.5 | −4.3 | −9 | −14 |
| RLint (%) | | 17.9 | 14.9 | 17.2 | 13.2 | 16 | 21.3 | 15.8 | 11.1 | 17 | 20 |
| a*Rint | | −4.7 | 1.0 | −4.1 | −0.3 | −2.4 | −4.6 | −1.3 | 2.2 | −4.5 | −10 |
| b*Rint | | 1.1 | −3.2 | −0.7 | −1.9 | −0.8 | −2.4 | 1.9 | 3.6 | −7 | −15 |
| a*Rext 60° | [−10; 0] | −7.7 | −4.7 | −8.1 | −5.4 | −5.5 | −0.1 | 0.7 | 5.8 | −5.7 | 1 |
| b*Rext 60° | [−10; 5] | −2.3 | −0.3 | −1.5 | 1.3 | −3.1 | −5 | −1.8 | −2 | −1.2 | −7.6 |
| g | 25-35% | 31.9 | 36.8 | 31.8 | 37.6 | 30.5 | 35.7 | 37.7 | 43.8 | 28 | 38 |

TABLE 5

| Properties | Targets | M1 | M2 | CM1 | CM2 | CM3 |
|---|---|---|---|---|---|---|
| ΔTL (%) | <4 | 1.8 | 2.5 | 4.4 | 3 | 3 |
| Δa*T | <3 | 2.4 | 1.7 | 0.6 | 1.3 | 1.5 |
| Δb*T | <3 | 2.2 | 1.2 | 1.7 | 0.5 | 3.5 |
| ΔRLext (%) | <4 | 0.9 | 1.1 | 3.7 | 0.5 | 2.2 |
| Δa*Rext | <3 | 0.5 | 2.0 | 3 | 6.6 | 7.5 |
| Δb*Rext | <3 | 2.7 | 0.6 | 1.2 | 3.8 | 5 |
| ΔRLint (%) | — | 3.0 | 4.0 | 5.3 | 4.7 | 3 |
| Δa*Rint | — | 5.8 | 3.8 | 2.2 | 3.5 | 5.5 |
| Δb*Rint | — | 4.3 | 1.2 | 1.6 | 1.7 | 8 |
| Δa*Rext 60° | <3 | 3.0 | 2.7 | 5.5 | 5.1 | 6.7 |
| Δb*Rext 60° | <3 | 2.0 | 2.8 | 1.9 | 0.2 | 6.4 |
| Δg | — | 4.9 | 5.8 | 5.1 | 4.7 | 10 |
| Delta C* T | <4.2 | 3.2 | 2.0 | 1.8 | 1.4 | 3.8 |
| Delta C* Rext | <4.2 | 2.7 | 2.1 | 3.2 | 7.7 | 9.0 |
| Delta C* Rint | <8.5 | 7.1 | 4.0 | 2.7 | 3.9 | 9.7 |
| Delta C* Rext 60° | <4.2 | 3.6 | 3.9 | 5.7 | 5.0 | 9.3 |

The materials CM1, CM2 and CM3 do not meet all the conditions for the thicknesses of the claimed layers. The aesthetic appearance of double glazed units and laminates are too far apart for the DGUs and laminated configurations to be considered visually similar to each other.

The material CM2 includes 2 silver-based functional layers instead of 3. The difference between DGU and laminate is too large on certain parameters and the aesthetics of the DGU and laminate are not visually similar.

The materials according to the invention, when they are mounted in the form of laminated glazed units or in the form of laminated glazed units, have sufficiently small color deviations.

1. A material comprising a transparent substrate coated with a functional coating successively including, starting from the substrate, an alternation of three silver-based functional metal layers referred to, starting from the substrate, as first, second and third silver-based functional layers and of four dielectric coatings, referred to, starting from the substrate Di1, Di2, Di3 and Di4 which each have an optical thickness, as Eo1, Eo2, Eo3 and Eo4, each dielectric coating including at least one dielectric layer, so that each functional metal layer is positioned between two dielectric coatings, wherein:
the dielectric coating Di1 has an optical thickness Eo1 of less than 80 nm,
the dielectric coating Di2 has an optical thickness Eo2 of less than 160 nm,
the dielectric coating Di3 has an optical thickness Eo3 of less than 160 nm,
the dielectric coating Di4 has an optical thickness Eo4 of less than 60 nm,
a ratio of the optical thicknesses Eo2/Eo1 is greater than 1.70 including this value,
a thickness of the second silver-based functional metal layer is less than 12 nm,
a ratio of a thickness of the third silver-based functional metal layer to a thickness of the first silver-based functional metal layer Ag3/Ag1 is greater than or equal to 1.20.

2. The material according to claim 1, wherein:
the first silver-based functional metal layer has a thickness between 7 and 11 nm,
the second silver-based functional metal layer has a thickness between 9 and 12 nm exclusive,
the third silver-based functional metal layer has a thickness between 12 and 18 nm.

3. The material according to claim 1, wherein:
the dielectric coating Di1 has an optical thickness between 57 and 80 nm,
the dielectric coating Di2 has an optical thickness between 124 and 144 nm,
the dielectric coating Di3 has an optical thickness between 144 and 160 nm,
the dielectric coating Di4 has an optical thickness between 30 and 55 nm.

4. The material according to claim 1, wherein the three silver-based functional metal layers satisfy the following characteristics:
a ratio of the thickness of the second silver-based functional metal layer to the thickness of the first silver-based functional metal layer Ag2/Ag1 is comprised between 1.05 and 2.00, or between 1.10 and 1.80, or between 1.10 and 1.50 inclusive, and/or
a ratio of the thickness of the third silver-based functional metal layer to the thickness of the second silver-based functional metal layer Ag3/Ag2 is comprised between 1.05 and 2.00, or between 1.10 and 1.80, or between 1.20 and 1.7 inclusive,
a ratio of the thickness of the third silver-based functional metal layer to the thickness of the first silver-based functional metal layer Ag3/Ag1 is comprised between 1.20 and 3.00 or between 1.50 and 2.50 inclusive.

5. The material according to claim 1, wherein the four dielectric layers are chosen from:
oxide layers of one or more elements selected from titanium, silicon, zirconium, iron, chromium, cobalt, manganese, tungsten, niobium, bismuth, tantalum, zinc and/or tin
nitride layers of one or more elements chosen from silicon, zirconium and aluminum,
oxynitride layers of one or more elements chosen from silicon, zirconium and aluminum,
metal sulfide layers such as zinc sulfide.

6. The material according to claim 1, wherein each silver-based functional metal layer is located below and/or above and in contact with a blocking layer based on at least one element chosen from nickel, chromium, niobium, tantalum and titanium.

7. The material according to claim 1, wherein the functional coating comprises, beginning from the substrate:
the dielectric coating Di1 comprising at least one layer based on sodium nitride and a layer based on zinc oxide,
optionally a blocking layer,
the first silver-based functional layer,
optionally a blocking layer,
the dielectric coating Di2 comprising at least three successive layers, a layer based on zinc oxide, a layer based on silicon nitride, and a layer based on zinc oxide,
optionally a blocking layer,
the second silver-based functional layer,
optionally a blocking layer,
the dielectric coating Di3 comprising at least three successive layers, a layer based on zinc oxide, a layer based on silicon nitride, and a layer based on zinc oxide,
optionally a blocking layer,
the third silver-based functional layer,
a blocking layer,
the dielectric coating Di4 comprising at least one layer based on zinc oxide, a layer based on silicon nitride and
optionally a protective layer.

8. The material according to claim 1, wherein the material has:
an interior and exterior light reflection less than 20%, and
light transmission between 50 and 70%.

9. A glazed unit comprising at least one material according to claim 1, wherein the glazed unit is in the form of a monolithic, laminated or multiple glazed unit.

10. The glazed unit according to claim 9, wherein the coating is positioned in the glazed unit so that incident light originating from outside passes through the dielectric coating Di1 before passing through the first silver-based functional metal layer.

11. The multiple glazed unit according to claim 9, comprising the material and at least one additional substrate, the material and the at least one additional substrate are separated by at least one interlayer gas gap.

12. The multiple glazed unit according to claim 11, wherein the glazed unit is a double glazed unit comprising the functional coating positioned on face 2:
a selectivity above 1.8,
a solar factor greater than 26%,
an interior and exterior light reflection less than 20%,
light transmission between 40 and 70%,
exterior reflection values of a* at 0 and 60° and transmission values comprised, by increasing order of preference, between −10 and +0, or between −5 and +0,
exterior reflection values of b* at 0 and 60° and transmission values comprised, by increasing order of preference, between −10 and +5, or between −5 and +0.

13. The laminated glazed unit according to claim 9, comprising a material and at least one additional substrate, the material and the at least one additional substrate are separated by at least one lamination interlayer.

14. The glazed unit in the form of a double glazed unit or of a laminated glazed unit according to claim 9, wherein color variations between a material mounted in the form of double glazed unit with the functional coating positioned on face 2 and a material mounted in the form of laminated glazed unit with the functional coating positioned on face 2 defined by Delta C* with Delta C*=√((a*_{DGU}−a*_{Lam})²−(b*_{DGU}−b*_{Lam})²) satisfy:
in transmission: Delta C*<4.2,
in exterior reflection: Delta C*<4.2,
in interior reflection: Delta C*<8.5,
in exterior reflection at 60°: Delta C*<4.2,
where a*_{DGU} and b*_{DGU} are the colorimetric coordinates of the material mounted in the form of a double glazed unit and a*_{Lam} and b*_{Lam} are the colorimetric coordinates of the material mounted in the form of laminated glazed unit in transmission, in exterior reflection, in interior reflection.

15. The material according to claim 2, wherein:
the first silver-based functional metal layer has a thickness between 7 and 10 nm,
the second silver-based functional metal layer has a thickness between 9 and 10 nm exclusive,
the third silver-based functional metal layer has a thickness between 13 and 17 nm.

16. The material according to claim 5, wherein the metal sulfide layers include a zinc sulfide layer.

17. The glazed unit according to claim 9, wherein the glazed unit is in the form of a double glazed unit or triple glazed unit.
